(19) United States
(12) Patent Application Publication
(10) Pub. No.: US 2012/0169873 A1
(43) Pub. Date: Jul. 5, 2012

(54) AUDIO/VIDEO MONITORING SYSTEM AND METHOD FOR SIMULTANEOUSLY PLAYING AUDIO/VIDEO

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 13/037,222

(22) Filed: Feb. 28, 2011

(30) Foreign Application Priority Data
Dec. 29, 2010 (TW) 99146599

(51) Int. Cl. H04N 7/18

(52) U.S. Cl. 348/143; 348/E07.085

(57) ABSTRACT

An exemplary method for displaying audio/video includes the following. A network camera is zoomed at a first zoom ratio to capture video images, and audio signals transmitted from a first area are simultaneously received. The network camera is zoomed at a second zoom ratio, and simultaneously audio signals transmitted from a second area are received. The video images and audio signals corresponding to the sounds of the first area and the second area are stored. The audio signals of the first area with the video images captured at the first zoom ratio are synchronized, and the audio signals of the second area with the video images captured at the second zoom ratio are also synchronized. Selected of the video images and the corresponding synchronized audio signals are simultaneously played, as required by a user.

### BACKGROUND

1. Technical Field

The present disclosure generally relates to monitoring devices and monitoring methods used in, for example, security surveillance.

2. Description of Related Art

Network cameras are widely used in security monitoring and surveillance systems. By utilizing pan-tilt-zoom (PTZ) function, a network camera can capture images at different distances, and users can freely and timely zoom-in or zoom-out the viewed images to meet special requirements. One drawback is that the network camera can only collect the sound around a nearby area, because a typical network camera utilizes only one embedded microphone. Therefore, the monitoring system can provide only the sound in the nearby area simultaneously with the corresponding images. Thus when an image of an area beyond the nearby area is captured, the microphone embedded in the network camera cannot adequately collect the corresponding sound. In other words, in a typical monitoring system, some of the images viewed do not have an accompanying simultaneous sound track playing.

What is needed, therefore, is an audio/video (A/V) monitoring system and a method for simultaneously displaying audio/video, to overcome the above-mentioned problems.

### BRIEF DESCRIPTION OF THE DRAWINGS

FIG. 1 is a schematic diagram of one embodiment of an audio/video monitoring system.

FIG. 2 is a functional block diagram of a network camera and a recorder of the audio/video monitoring system of FIG. 1, together with a monitor.

FIG. 3 is a flowchart illustrating one embodiment of a method for simultaneously displaying audio/video, the method typically performed by using the audio/video monitoring system of FIG. 1.

### DETAILED DESCRIPTION

The disclosure is illustrated by way of example and not by way of limitation in the figures of the accompanying drawings. In the various figures, like reference numerals indicate similar elements. It should be noted that references to “an” or “one” embodiment in this disclosure are not necessarily to the same embodiment, and such references can include the meaning of at least one.

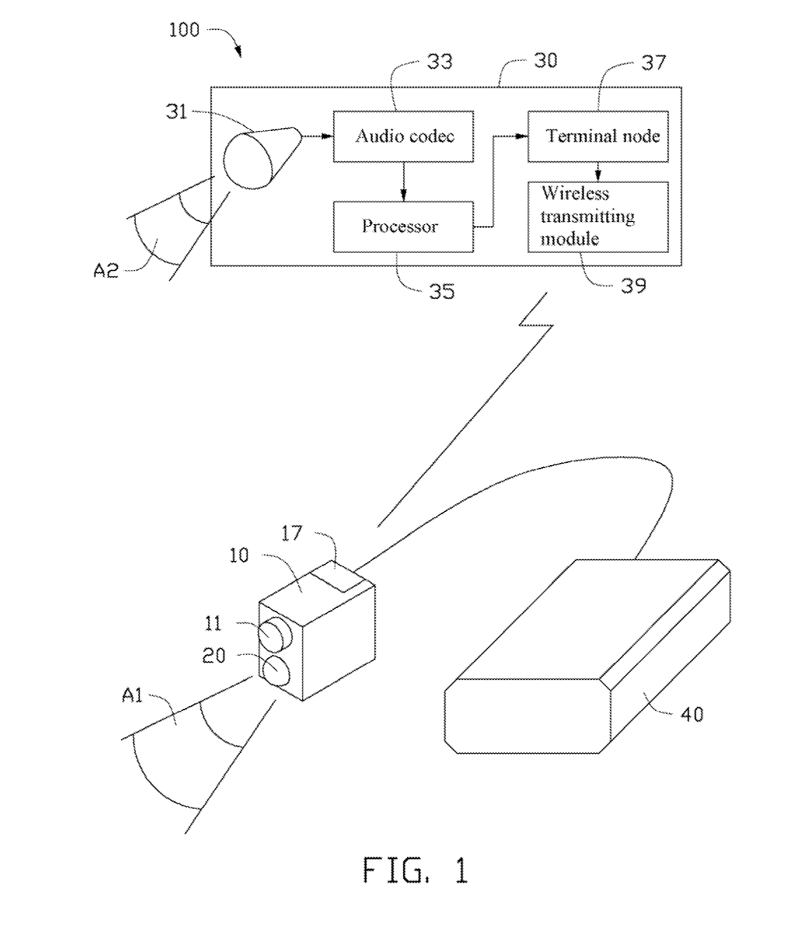

FIG. 1 is a schematic diagram of one embodiment of an audio/video (A/V) monitoring system 100. The A/V monitoring system 100 includes a network camera 10, a first audio receiving module 20 embedded in the network camera 10, a second audio receiving module 30 wirelessly connected to the network camera 10, and a recorder 40 in communication with the network camera 10. In general, the word “module,” as used herein, refers to logic embodied in hardware or firmware, or to a collection of software instructions written in a programming language such as, for example, Java, C, or Assembly. One or more software instructions in the modules may be embedded in firmware, such as an erasable-programmable read-only memory (EPROM). It will be appreciated that modules may comprise connected logic units, such as gates and flip-flops, and may comprise programmable units, such as programmable gate arrays or processors. The modules described herein may be implemented as software and/or hardware modules and may be stored in any type of computer-readable medium or other storing module.

The first audio receiving module 20 receives sounds transmitted from a first area A1 which is in the vicinity of the first audio receiving module 20. In the present embodiment, the first area A1 is away from the position of the network camera 10 by about 2 or 3 inches. In this embodiment, the first audio receiving module 20 is a microphone embedded in the network camera 10.

The second audio receiving module 30 receives sounds transmitted from a second area A2 which is in the vicinity of the second audio receiving module 30. A distance between the second area A2 and the position of the network camera 10 is longer than that between the first area A1 and the position of the network camera 10. The second audio receiving module 30 includes a sound capturing device 31, an audio codec 33, a processor 35, a terminal node 37, and a wireless transmitting module (radio emitting unit) 39. In this embodiment, the sound capturing device 31 is a microphone. The sound capturing device 31 collects, e.g., a voice in the second area A2, and converts the voice to audio signals. The audio signals are compressed and encoded by the audio codec 33, and then decoded and converted into a readable format by the processor 35. The processor 35 transmits the readable signals to the terminal node 37. The terminal node 37 transmits the readable signals to the wireless transmitting module 39 using a predetermined communication protocol. The wireless transmitting module 39 transmits the readable signals to the network camera 10 by radio waves.

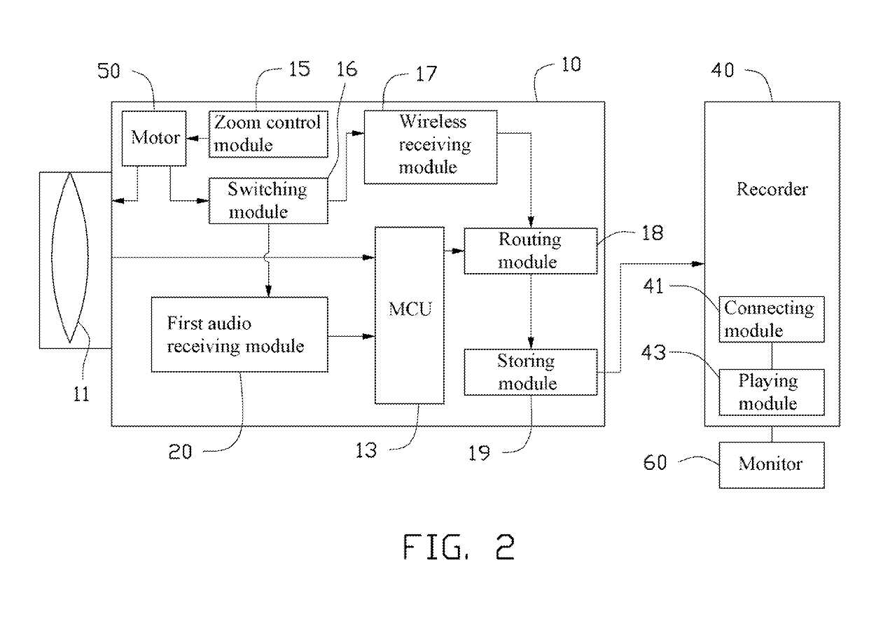

Referring also to FIG. 2, the network camera 10 is operable to obtain a plurality of video streams by operation of a pan-tilt-zoom (PTZ) function therein, and the video streams are converted into electronic video signals. In the present embodiment, the network camera 10 includes a zoom lens 11 and a micro-programmed control unit (MCU) 13. The zoom lens 11 is operable to use a first zoom ratio to capture the video images within a first focal distance, and a second zoom ratio to capture the video images within a second focal distance. The second zoom ratio is larger than the first zoom ratio in this embodiment. The MCU 13 receives video signals corresponding to the video images from the zoom lens 11, and is also in communication with the first audio receiving module 20. The MCU 13 can compress/encode the video signals, and can compress/encode audio signals received from the first audio receiving module 20. The MCU 13 then transmits the video signals and audio signals to the routing module 18.

In other embodiments, the network camera 10 is not limited to implementing the first and second zoom ratios. In particular, the network camera 10 can implement a further one or more zoom ratios, e.g., a third zoom ratio and a fourth zoom ratio.

The network camera 10 further includes a zoom control module 15, a switching module 16, a wireless receiving module 17, a routing module 18, and a storing module 19. In this embodiment, the first audio receiving module 20, the zoom control module 15, the switching module 16, the wireless receiving module 17, the routing module 18, and the storing module 19 are incorporated in the network camera 10. In general, one or more computerized codes of the various modules 15, 16, 17, and/or 18 may be stored in the storing module 19.

The zoom control module 15 is configured for controlling the network camera 10 to zoom according to the first zoom ratio or the second zoom ratio, as needed. In this embodiment, the zoom control module 15 is electrically connected to a motor 50 assembled with the zoom lens 11, and triggers the motor 50 to drive the zoom lens 11 to zoom according to the first zoom ratio or the second zoom ratio as required.

The switching module 16 is configured for activating the first audio receiving module 20 to start receiving sounds, or activating the wireless receiving module 17 to start receiving the audio signals from the second audio receiving module 30, according to the zoom ratio currently executed by the zoom control module 15. For example, when the zoom control module 15 starts controlling the network camera 10 to implement the first zoom ratio, the switching module 16 activates the first audio receiving module 20 to start receiving sounds. When the zoom control module 15 starts controlling the network camera 10 to implement the second zoom ratio, the switching module 16 deactivates the first audio receiving module 20 and simultaneously activates the wireless receiving module 17 to start receiving the audio signals from the second audio receiving module 30. In this embodiment, the switching module 16 is electrically connected to the motor 50. When the zoom control module 15 controls the zoom lens 11 to zoom at the first zoom ratio, the motor 50 is controlled to output a first control signal to the switching module 16, to signal the first audio receiving module 20 to capture sound in the first area A1. When the zoom control module 15 controls the zoom lens 11 to zoom at the second zoom ratio, the motor 50 is controlled to output a second control signal to the switching module 16, to signal the first audio receiving module 20 to cease operating and activate the wireless receiving module 17 to receive the audio signals from the second audio receiving module 30.

The wireless receiving module 17 is in communication with the routing module 18, and with the wireless transmitting module 39 of the second audio receiving module 30. The wireless receiving module 17 is configured for receiving the audio signals transmitted from the wireless transmitting module 39. After the wireless receiving module 17 receives the audio signals transmitted from the second audio receiving module 30, the wireless receiving module 17 transmits the audio signals to the routing module 18. The wireless receiving module 17 can further modulate/demodulate and compress/decompress/encode the audio signals before it transmits the audio signals to the routing module 18.

It is understood that in other embodiments, the second audio receiving module 30 is in communication with the receiving module 17 via cables or wires. That is, in such case, the receiving module 17 is a wired receiving module 17.

The routing module 18 is configured for providing a route to transmit all of the audio signals received to the storing module 19. In this embodiment, the routing module 18 transmits the audio signals using a ZigBee protocol.

The storing module 19 is configured for storing (i.e., in the form of video data) the video images captured by the zoom lens 11, and storing (i.e., in the form of audio data or an audio track) the audio signals from the first audio receiving module 20 and the routing module 18. In this embodiment, the storing module 19 can be a flash memory.

The recorder 40 is electrically connected to the storing module 19. The recorder 40 is operable to record and play (in real time or by way of playback) the video images and the corresponding audio tracks according to a user's operations. The video images are displayed on a monitor 60. Thus, the user can browse and manually zoom the video images displayed on the monitor 60 to visually and easily determine whether the monitored area has abnormalities or anomalies.

Additionally, in order to play (in real time or by way of playback) any of the video images and the corresponding audio track simultaneously, the recorder 40 further includes a connecting module 41 and a playing module 43. The connecting module 41 is configured for synchronizing the audio track of sound input from the first area A1 with the video images captured at the first zoom ratio, and synchronizing the audio track of sound input from the second area A2 with the video images captured at the second zoom ratio. The playing module 43 is configured for playing any of the video images and the corresponding audio track simultaneously, according to operation by the user and the connections established by the connecting module 41. In this embodiment, when the video images are zoomed according to a zoom ratio input by the user, the playing module 43 simultaneously plays the corresponding video images and the accompanying audio track. For example, the first zoom ratio is set to be 3× (a magnification of 3 times), and the second zoom ratio is set to be 5× (a magnification of 5 times), where × indicates an original or base size of objects in the video image viewed. When the user inputs an order (instruction) for 3×, the playing module 43 simultaneously plays the video images and the corresponding sounds collected from the first area A1. When the user inputs an order (instruction) for 5×, the playing module 43 simultaneously plays the video images and the sounds collected from the second area A2.

In another embodiment, the video images captured at the first zoom ratio 3× and at the second zoom ratio 5× are both played simultaneously, using a split screen on the monitor 60. In such case, typically, only the audio track accompanying one of the two video images being displayed is played.

On the other hand, in order to provide automatic surveillance with sound and video capture and playing in real time, in one embodiment, the playing module 43 can automatically play the video images and corresponding audio track according to a currently set zoom ratio (i.e., the first zoom ratio or the second zoom ratio). That is, as long as the zoom lens 11 is working at the first zoom ratio or the second zoom ratio, the playing module 43 can simultaneously play the corresponding video images and accompanying audio track. As such, the user is not required to choose or adjust the zoom ratio, because the recorder 40 can simultaneously play the video images and corresponding audio track according to the zoom ratio already set.

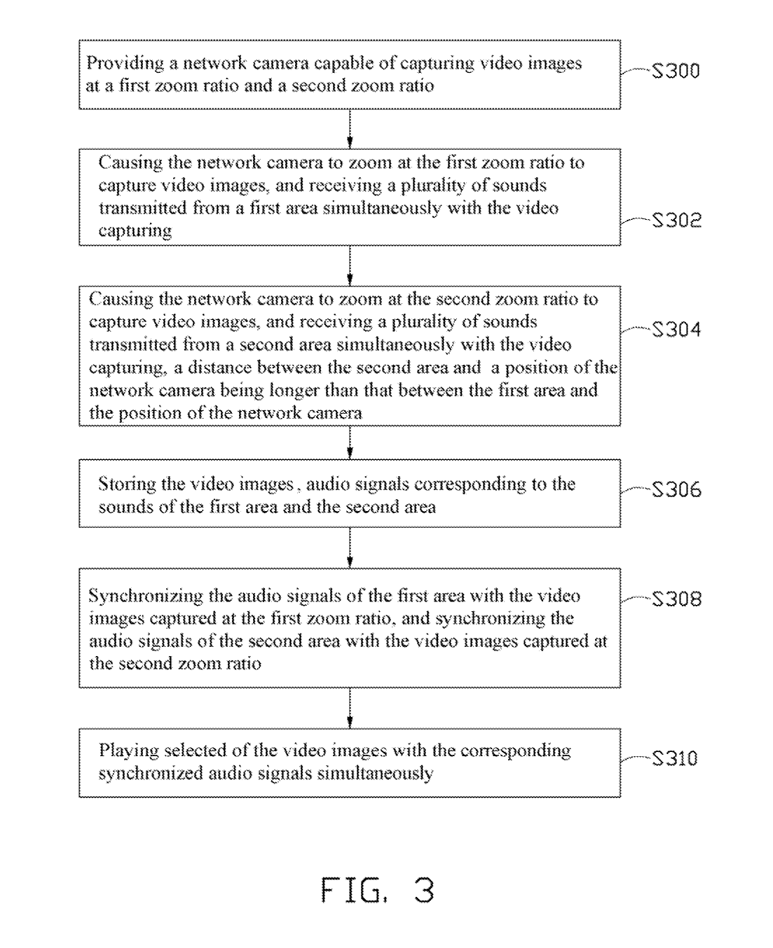

FIG. 3 is a flowchart illustrating one embodiment of a method for simultaneously displaying audio/video, the method typically performed by using the A/V monitoring system 100.

In step S300, a network camera 10 capable of capturing video images at the first zoom ratio and the second zoom ratio is provided. In this embodiment, the second zoom ratio is larger than the first zoom ratio. More particularly, in this embodiment, the first zoom ratio is set to be 3×, and the second zoom ratio is set to be 5×.

In step S302, a first audio receiving module 20 embedded in the network camera 10 is provided, whereby a plurality of sounds transmitted from a first area A1 can be received. In detail, when the network camera 10 starts the first zoom ratio, a plurality of sounds transmitted from the first area A1 is concurrently received by the first audio receiving module 20. The video images captured, and audio signals corresponding to the sounds, are transmitted to an MCU 13. In the present embodiment, the first area A1 is away from the position of the network camera 10 by about 2 or 3 inches.

In step S304, a second audio receiving module 30 in communication with the network camera 10 is provided, whereby a plurality of sounds transmitted from a second area A2 can be received. In detail, when the network camera 10 starts the second zoom ratio, a plurality of sounds transmitted from the second area A2 is received by the second audio receiving module 30. The video images captured are transmitted to the MCU 13. Audio signals corresponding to the sounds are transmitted to a routing module 18. The distance between the second area A2 and the position of the network camera 10 is longer than that between the first area A1 and the position of the network camera 10. In the present embodiment, the distance between the second area A2 and the position of the network camera 10 is about 7 inches or more.

In step S306, the video images and the audio signals corresponding to the sounds input from the first and second areas A1 and A2 are stored in a storing module 19.

In step S308, the video images captured at the first zoom ratio and the audio signals of the first area A1 are synchronized, and the video images captured at the second zoom ratio and the audio signals of the second area A2 are synchronized, so that any of the video images and the corresponding audio signals can be played at the same time.

In step S310, any of the video images and the corresponding audio signals are simultaneously played as required, according to operation by a user and the synchronized relationship between the video images and the audio signals established in step S308. In this embodiment, when the video images are zoomed according to the first zoom ratio input by the user, the video images and the corresponding sounds input from the first area A1 are simultaneously played. When the video images are zoomed according to the second zoom ratio input by the user, the video images and the corresponding sounds input from the second area A2 are simultaneously played. Thus, the desired video images and the corresponding audio signals can be played simultaneously.

All of the processes described above may be embodied in, and fully automated via, functional code modules executed by one or more general purpose processors of computing devices. The functional code modules may be stored in any type of readable medium or other storage module. Some or all of the methods may alternatively be embodied in one or more specialized computing devices.

In one alternative embodiment, the wireless receiving module 17 is connected to the MCU 13 instead of to the routing module 18. After the wireless receiving module 17 receives the audio signals transmitted from the second audio receiving module 30, the wireless receiving module 17 transmits the audio signals to the MCU 13. The MCU 13 can compress/encode the audio signals. The MCU 13 then transmits the audio signals to the routing module 18.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. An audio/video monitoring system, comprising:
at least one network camera;
at least one first audio receiving module configured for receiving a plurality of sounds transmitted from a first area in the vicinity of the at least one first audio receiving module;
at least one second audio receiving module configured for receiving a plurality of sounds transmitted from a second area in the vicinity of the at least one second audio receiving module, a distance between the second area and a position of the at least one network camera being longer than that between the first area and the position of the at least one network camera;
a receiving module configured for receiving audio signals transmitted from the at least one second audio receiving module, the audio signals corresponding to the sounds received by the at least one second audio receiving module;
a zoom control module configured for controlling the at least one network camera to zoom according to a first zoom ratio and a second zoom ratio to capture a plurality of video images;
a switching module configured for actuating the at least one first audio receiving module to start receiving sounds or the receiving module to start receiving the audio signals, according to whether a current zoom ratio is the first zoom ratio or the second zoom ratio, respectively;
a storing module configured for storing the video images, audio signals corresponding to the sounds input to the at least one first audio receiving module, and the audio signals received by the receiving module;
a connecting module configured for synchronizing the audio signals of the first area with the video images captured at the first zoom ratio, and synchronizing the audio signals of the second area with the video images captured at the second zoom ratio; and
a playing module configured for playing the video images captured at the first zoom ratio and the corresponding synchronized audio signals simultaneously or playing the video images captured at the second zoom ratio and the corresponding synchronized audio signals simultaneously, as selected.

2. The audio/video monitoring system of claim 1, wherein the receiving module is a wireless receiving module, the at least one second audio receiving module comprises a sound capturing device, an audio codec, a processor, a terminal node, and a wireless transmitting module, the sound capturing device collects the sounds in the second area and converts the sounds to the corresponding audio signals, the audio signals are compressed and encoded by the audio codec and then decoded and converted to a readable format by the processor, the processor transmits the readable audio signals to the terminal node, the terminal node transmits the readable audio signals to the wireless transmitting module using a predetermined communication protocol, and the wireless transmitting module wirelessly transmits the readable audio signals to the wireless receiving module.

3. The audio/video monitoring system of claim 1, wherein the audio/video monitoring system further comprises a routing module configured for providing a route to transmit all of the audio signals received to the storing module.

4. The audio/video monitoring system of claim 3, wherein the routing module transmits the audio signals using a ZigBee protocol.

5. The audio/video monitoring system of claim 1, wherein when the zoom control module starts implementing the first zoom ratio, the switching module activates the at least one first audio receiving module to start receiving the corresponding sounds; and when the zoom control module starts implementing the second zoom ratio, the switching module deactivates the at least one first audio receiving module, and concurrently activates the receiving module to start receiving the corresponding audio signals.

6. The audio/video monitoring system of claim 1, further comprising a motor, wherein the zoom control module and the switching module are both electrically connected to the motor, the motor is controlled to output a first control signal to the switching module when the zoom control module implements the first zoom ratio, and is controlled to output a second control signal to the switching module when the zoom control module implements the second zoom ratio, the first control signal signals the at least one first audio receiving module to operate, and the second control signal signals the at least one first audio receiving module to cease operating and concurrently signals the receiving module to operate.

7. The audio/video monitoring system of claim 1, further comprising a recorder comprising the connecting module and the playing module, wherein the recorder is configured for recording the video images and the corresponding synchronized audio signals, and playing the video images captured at the first zoom ratio and the corresponding synchronized audio signals simultaneously or playing the video images captured at the second zoom ratio and the corresponding synchronized audio signals simultaneously, according to a user's operations.

8. The audio/video monitoring system of claim 7, further comprising a monitor, wherein the played video images are displayed on the monitor.

9. The audio/video monitoring system of claim 1, wherein the first audio receiving module, the receiving module, the routing module, the zoom control module, the switching module, and the storing module are incorporated in the at least one network camera.

10. A method for simultaneously displaying audio/video, the method comprising:
causing a network camera to zoom at a first zoom ratio to capture video images, and receiving a plurality of sounds transmitted from a first area simultaneously with the video capturing;
causing the network camera to zoom at a second zoom ratio to capture video images, and receiving a plurality of audio signals corresponding to sounds transmitted from a second area simultaneously with the video capturing, wherein a distance between the second area and a position of the network camera is longer than that between the first area and the position of the network camera;
storing the video images, audio signals corresponding to the sounds of the first area, and the audio signals corresponding to the sounds of the second area;
synchronizing the audio signals of the first area with the video images captured at the first zoom ratio, and synchronizing the audio signals of the second area with the video images captured at the second zoom ratio; and
playing selected of the video images simultaneously with the corresponding synchronized audio signals.

11. The method for simultaneously displaying audio/video of claim 10, wherein the video images captured at the first zoom ratio and the video images captured at the second zoom ratio are both played simultaneously, and one of the video images captured at the first zoom ratio and the video images captured at the second zoom ratio are played simultaneously with the corresponding synchronized audio signals.

12. The method for simultaneously displaying audio/video of claim 10, wherein the video images captured at the first zoom ratio with the corresponding synchronized audio signals and the video images captured at the second zoom ratio with the corresponding synchronized audio signals are played at separate times.

13. A method for simultaneously displaying audio/video, the method comprising:
causing a network camera to capture video images at a first zoom ratio and at a second zoom ratio;
providing a first audio receiving module embedded in the network camera, and actuating the first audio receiving module to receive a plurality of sounds input from a first area when the video images are captured at the first zoom ratio;
providing a second audio receiving module in communication with the network camera, and actuating the second audio receiving module to receive a plurality of sounds input from a second area when the video images are captured at the second zoom ratio, wherein a distance between the second area and a position of the network camera is longer than that between the first area and the position of the network camera;
synchronizing audio signals corresponding to the sounds received by the first audio receiving module with the video images captured at the first zoom ratio, and synchronizing audio signals corresponding to the sounds received by the second audio receiving module with the video images captured at the second zoom ratio;
playing the video images captured at the first zoom ratio simultaneously with the corresponding synchronized audio signals; and
playing the video images captured at the second zoom ratio simultaneously with the corresponding synchronized audio signals.

14. The method for simultaneously displaying audio/video of claim 13, wherein the second zoom ratio is larger than the first zoom ratio.

15. The method for simultaneously displaying audio/video of claim 13, further comprising:
activating the first audio receiving module to start receiving sounds, or starting receiving the audio signals corresponding to the sounds received by the second audio receiving module, according to whether a current zoom ratio is the first zoom ratio or the second zoom ratio, respectively; and
storing the video images and the corresponding audio signals from the first audio receiving module or the second audio receiving module.
